(19) United States
(12) Patent Application Publication
(10) Pub. No.: US 2024/0391277 A1
(43) Pub. Date: Nov. 28, 2024

(54) PNEUMATIC TIRE WITH 3D KERF

(71) Applicant: HANKOOK TIRE & TECHNOLOGY., LTD., Seongnam-si (KR)

(72) Inventors: Jae Wook IHM, Sejiong-si (KR); Woo Haeng HEO, Daejeon (KR)

(21) Appl. No.: 18/797,886

(22) Filed: Aug. 8, 2024

Related U.S. Application Data
(63) Continuation of application No. 17/336,981, filed on Jun. 2, 2021.

(30) Foreign Application Priority Data
Jun. 2, 2020 (KR) 10-2020-0066290

(51) Int. Cl. B60C 11/12; B60C 11/18

(52) U.S. Cl. CPC B60C 11/1218; B60C 11/18; B60C 11/185; B60C 2011/1213

(57) ABSTRACT

According to the invention, there is provided a pneumatic tire with a 3D kerf, including: one or more 3D kerfs; and a tire having a tread and a shoulder formed at a side surface of the tread. The tread has: one or more grooves that are sunken toward a center of the tread and are formed in a circumferential direction of the tire; one or more kerf grooves that are sunken toward the center of the tread and are formed in a central axis direction of the tire; and one or more blocks which are divided by the one or more grooves and the one or more kerf grooves, respectively. The one or more 3D kerfs come into close contact with and are fixed between the one or more blocks, respectively, as being inserted into the one or more kerf grooves, respectively.

### BACKGROUND OF THE INVENTION

### Field of the Invention

The present invention relates to a pneumatic tire with a 3D kerf, and more specifically, to a pneumatic tire with a 3D kerf for improving a snow performance.

### Description of the Related Art

A pneumatic tire is configured to include an inner liner that forms the inside of the tire, a body ply stacked on the outside of the inner liner, a belt stacked on the outside of the body ply, a tread stacked on the outside of the belt, sidewalls forming both side portions of the tire, and a bead coupled to a wheel.

In addition, the tread which grips a road surface has a specifically shaped pattern formed to enhance grip force, drainage, braking force, noise dispersion, or the like, and a shape of the pattern significantly affects a tire performance on rainy and snowy roads and a handling performance. Hence, the shape of the pattern is a major factor in tire development. A kerf is a deep groove which is often cut in a transverse direction in a tread block to have a narrow width of 1 mm or narrower, and the kerf provides cushioning to bring about a comfortable ride while enabling a ground gripping surface to be even and enhancing grip force. In addition, the kerf has a function of facilitating rapid drainage to increase driving force and braking force.

Recently, the pattern design tends to more focus on performance rather than on a simple design and an external appearance. A pattern performance technology is subdivided and changed into fine ranges for tire performance.

In addition, when a snow tire rotates on a road surface, the edge effect due to the kerf enables the snow tire to be driven and braked, and thus it is possible to ensure a snow performance of the tire during running of a vehicle.

The kerf which is applied to the snow tire for the edge effect reduces strength of a tread rubber block, thus resulting in degrading the tire performance on a dry road surface. In this respect, in order to secure the strength of a block by improving a confinement performance by a kerf in a perpendicular direction from a surface of a tire, application of a 3D kerf is increased. In general, when a snow tire with a kerf is driven, there occurs a phenomenon in which a block of the snow tire collapses too much or a leading portion of the block is rolled inward in a moving direction of the tire, and thus there often occurs a phenomenon of a reduction in frictional force due to friction with a road surface.

The edge effect occurs at the leading portion of a tread block during driving and occurs at a tailing portion of the block during braking, and thus there occurs a phenomenon of an increase in ground grip pressure more than that at other portions in the block. The increase in ground grip pressure in a condition where a hydroplaning and a snow layer are formed between a road surface and a tire causes a friction coefficient to be increased by breaking the hydroplaning and the snow layer. A problem arises in that, as density of kerfs increases, an existing kerf structure causes the strength of a block to be decreased and has no effect on the wet and snow performance due to a reduction in edge effect with a reduction in ground grip pressure which results from an increase in block sliding and an increase in ground grip surface, or an abnormal wear phenomenon occurs.

### CITATION LIST

### Patent Literature

Patent Literature 1: Korean Patent Registration No. 10-1739506 (May 18, 2017)

Patent Literature 2: Korean Patent Registration No. 10-1711130 (Feb. 22, 2017)

### SUMMARY OF THE INVENTION

An object of the invention to solve the above-described problem is to provide a pneumatic tire with a 3D kerf which improves a snow performance by inserting the 3D kerf into a kerf groove of a tire tread, the 3D kerf including a top surface having a wave shape and a side surface having a trapezoid shape.

In addition, another object of the invention to solve the above-described problem is to provide a pneumatic tire with a 3D kerf which improves a ground grip force and handling and braking performances of the tire by causing an interlocking phenomenon between blocks as one or more 3D kerfs come into close contact with and are fixed between one or more blocks while being inserted into one or more kerf grooves.

Technical objects to be achieved by the invention are not limited to the technical objects mentioned above, and the following description enables other unmentioned technical objects to be clearly understood by a person of ordinary skill in the art to which the invention pertains.

According to a configuration of the invention to achieve the above-described objects, there is provided a pneumatic tire with a 3D kerf, including: one or more 3D kerfs; and a tire having a tread and a shoulder formed at a side surface of the tread. The tread has: one or more grooves that are sunken toward a center of the tread and are formed in a circumferential direction of the tire; one or more kerf grooves that are sunken toward the center of the tread and are formed in a central axis direction of the tire; and one or more blocks which are divided by the one or more grooves and the one or more kerf grooves. The one or more 3D kerfs come into close contact with and are fixed between the one or more blocks as being inserted into the one or more kerf grooves.

In an embodiment of the invention, each of the 3D kerfs may have: a flat portion including one or more flat members having a flat-plate shape; a recessed portion including one or more recessed members which have a predetermined curvature and are formed to recess in one direction of the circumferential direction; and a protruded portion including one or more protruded members which have a predetermined curvature and are formed to protrude in the other direction of the circumferential direction. The flat portion, the recessed portion, and the protruded portion may be continuously connected.

In the embodiment of the invention, the flat portion may have: a first flat member which is positioned inside the kerf groove at one side; a second flat member which is coupled to the first flat member; a third flat member which is positioned inside the kerf groove at the other side; and a fourth flat member which is coupled to the third flat member. The flat portion may come into close contact with and may be fixed between a pair of adjacent blocks among the one or more blocks.

In the embodiment of the invention, the recessed portion may have: a first recessed member which is connected to the first flat member; and a second recessed member which is connected to the second flat member and is coupled to the first recessed member. The protruded portion may have: a first protruded member which is connected to the first recessed member; and a second protruded member which is connected to the second recessed member and is coupled to the first protruded member. The first and second flat members, the first and second recessed members, and the first and second protruded members may be connected in consecutive order, and a shortest distance between both ends of the first and second recessed members may be equal to a shortest distance between both ends of the first and second protruded members.

In the embodiment of the invention, the recessed portion may have: a third recessed member which is connected to the third flat member; and a fourth recessed member which is connected to the fourth flat member and is coupled to the third recessed member. The protruded portion may have: a third protruded member which is connected to the third recessed member; and a fourth protruded member which is connected to the fourth recessed member and is coupled to the third protruded member. The third and fourth flat members, the third and fourth recessed members, and the third and fourth protruded members may be connected in consecutive order, and a shortest distance between both ends of the third and fourth recessed members may be equal to a shortest distance between both ends of the third and fourth protruded members.

In the embodiment of the invention, a shortest distance from one end of the first and second recessed members connected to the first and second flat members to the other end of the first and second protruded members may be 5 mm to 12 mm.

In the embodiment of the invention, the 3D kerfs may have a thickness of 0.2 mm to 0.4 mm.

In the embodiment of the invention, a top surface of the 3D kerf may have a wave shape which bends alternately one or more times, the top surface being parallel to a surface of the tread.

In the embodiment of the invention, a side surface of each of the 3D kerfs has a trapezoid shape which bends alternately one or more times, the side surface being parallel to the one or more blocks, and a shortest distance from one end of a recessed part of the side surface of the 3D kerf to one end of a protruded part of the side surface of the 3D kerf may be 2 mm to 3 mm.

### BRIEF DESCRIPTION OF THE DRAWINGS

FIG. 1 is a perspective view in one direction illustrating a pneumatic tire with

a 3D kerf according to an embodiment of the invention; FIG. 2 is a partially-detailed view illustrating enlargement of region S in FIG. 1;

FIG. 3 is a cross-sectional view taken along line a-b in FIG. 2;

FIGS. 4A-B are perspective views illustrating shapes of a 3D kerf of the pneumatic tire with a 3D kerf according to the embodiment of the invention; and

FIGS. 5A-D are perspective views illustrating actual shapes of the 3D kerf of the pneumatic tire with a 3D kerf according to the embodiment of the invention.

### DETAILED DESCRIPTION OF THE PREFERRED EMBODIMENT

Hereinafter, the invention is to be described with reference to the accompanying drawings. However, the invention can be realized as various different examples and thus is not limited to an embodiment described herein. Besides, a part unrelated to the description is omitted from the drawings in order to clearly describe the invention, and similar reference signs are assigned to similar parts through the entire specification.

In the entire specification, a case where a certain part is “connected to (attached to, in contact with, or coupled to)” another part means not only a case where the parts are “directly connected” to each other, but also a case where the parts are “indirectly connected” to each other with another member interposed therebetween. In addition, a case where a certain part “comprises” a certain configurational element does not mean that another configurational element is excluded but means that other configurational elements can be further included unless specifically described otherwise.

Terms used in this specification are only used to describe a specific embodiment and are not intentionally used to limit the invention thereto. A singular form of a noun includes a plural meaning of the noun unless obviously implied otherwise in context. In this specification, words such as “to comprise” or “to include” are to be understood to specify that a feature, a number, a step, an operation, a configurational element, a member, or a combination thereof described in the specification is present and not to exclude a possibility of presence or addition of one or more other features, numbers, steps, operations, configurational elements, members, or combinations thereof in advance.

Hereinafter, an embodiment of the invention will be described in detail with reference to the accompanying drawings.

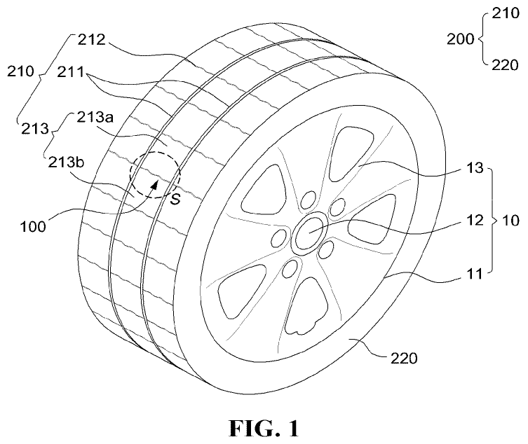

FIG. 1 is a perspective view in one direction illustrating a pneumatic tire with a 3D kerf according to the embodiment of the invention.

First, a tire 200, into which a 3D kerf 100 is inserted, and a tire wheel 10 which supports the tire 200 are to be described.

With reference to FIG. 1, the tire 200 has a tread 210 and a shoulder 220 formed at a side surface of the tread 210. In addition, although not illustrated in FIG. 1, a belt, an inner liner, a cap ply, a carcass, a bead, or the like can be formed on the tire 200, and these configurational elements correspond to known technologies. Hence, the detailed description thereof is to be limited.

The tread 210 includes a groove 211, a kerf groove 212, and a block 213.

The groove 211 is sunken toward a center of the tread 210 and is formed in a circumferential direction of the tire 200, thus, fulfilling a function of drainage, and one or more (three in FIG. 1) grooves 211 are formed as illustrated in FIG. 1.

The kerf grooves 212 are sunken toward the center of the tread 210 and are formed in a central axis direction of the tire 200. When the tread 210 is formed in a vertical direction based on FIG. 1, the kerf grooves 212 is formed in a horizontal direction, and one or more (36 in FIG. 1) kerf grooves 212 are formed as illustrated in FIG. 1.

In addition, a shape of the kerf groove 212 is not limited to the shape illustrated in FIG. 1, and the kerf groove is formed to have a shape such that the 3D kerf 100 to be described below is inserted to come into close contact with one or more blocks 213.

In this respect, a side surface of the one or more blocks 213 can be formed in parallel with one or more blocks 213 to be parallel to a side surface of the 3D kerf 100.

The blocks 213 are divided by the one or more grooves 211 and the one or more kerf grooves 212, and one or more (18 in FIGS. 1 and 57 as individual blocks such as first blocks and second blocks) blocks 213 are formed as illustrated in FIG. 1.

The blocks 213 grips a road surface and enables a vehicle to be stopped due to a frictional force.

In the invention, reference signs are assigned to a pair of blocks among adjacent blocks for the description.

The pair of blocks are a first block 213a and a second block 213b.

The first block 213a and the second block 213b are divided by the groove 211 and the kerf groove 212, and thus the first block 213a and the second block 213b are positioned to be separated from each other as much as the kerf groove 212 is formed.

The shoulder 220 is formed at a side of the tread 210 and comes into close contact with the tire 200 when the tire 200 is mounted on the tire wheel 10.

With reference to FIG. 1, the tire wheel 10 includes a cylindrical rim 11 having both sides which are open, a disc 12 positioned at a central portion of the rim 11, and one or more spokes 13 which connect the rim 11 and the disc 12.

Hereinafter, a pneumatic tire with a 3D kerf according to the embodiment of the invention is to be described with reference to FIGS. 1 to 5.

With reference to FIG. 1, the pneumatic tire with a 3D kerf according to the embodiment of the invention includes the 3D kerf 100 and the tire 200.

The 3D kerf 100 is inserted into and fixed in the kerf groove 212 formed between a pair of adjacent blocks, and one or more 3D kerfs are formed to be inserted into the one or more kerf grooves 212.

In addition, since the one or more 3D kerfs 100 come into close contact with and are fixed between the one or more blocks 213 as being inserted into the one or more kerf grooves 212, an interlocking phenomenon between blocks occurs to improve a ground grip force and handling and braking performances of the tire 200.

The 3D kerf 100 according to the embodiment is manufactured of one of stainless steel (SUS304, SUS301, SUS420J2, and SUS630) materials by performing bending thereon. The 3D kerf 100 can be manufactured by performing 3D printing on one material of maraging steel, SUS630, and Ti powder, in addition to the stainless steel materials.

In addition, the frictional force changes depending on a shape of the 3D kerf 100, and the detailed description thereof is to be provided below.

In this respect, the 3D kerf 100 has a flat portion 110, a recessed portion 120, and a protruded portion 130.

FIG. 2 is a partially-detailed view illustrating enlargement of region S in FIG. 1.

The flat portion 110 comes into close contact with and is fixed between the pair of adjacent blocks 213a and 213b among the one or more blocks 213.

With reference to FIG. 2, the flat portion 110 includes a first flat member 111, a second flat member 112, a third flat member 113, and a fourth flat member 114 which are one or more flat members having a flat-plate shape.

The first flat member 111 has the flat-plate shape and is positioned inside the kerf groove 212 at one side.

The second flat member 112 has the same shape and size as the first flat member 111 and is coupled to the first flat member 111.

The third flat member 113 has the flat-plate shape, has the same shape and size as the first flat member 111 and the second flat member 112, and is positioned inside the kerf groove 212 at the other side.

The fourth flat member 114 has the same shape and size as the third flat member 113 and is coupled to the third flat member 113.

The first and second flat members 111 and 112 are positioned on the left side based on FIG. 2, and the third and fourth flat members 113 and 114 are positioned on the left side based on FIG. 2.

The recessed portion 120 has a predetermined curvature and is formed to recess in one direction of the circumferential direction of the tire 200. The recessed portion 120 includes a first recessed member 121, a second recessed member 122, a third recessed member 123, and a fourth recessed member 124 which are one or more recessed members.

As illustrated in FIG. 2, the first recessed member 121 is connected to the first flat member 111. Specifically, one side of the first recessed member 121 is connected to the other side of the first flat member 111, and the other side of the first recessed member 121 is connected to one side of a first protruded member 131.

In addition, the first recessed member 121 is formed to recess downward so as to have a predetermined curvature as illustrated in FIG. 2.

Here, a radius R1 of the first recessed member 121 is preferably 6.6021 mm; however, the radius is not limited thereto.

The second recessed member 122 is connected to the second flat member 112 and is coupled to the first recessed member 121. Specifically, one side of the second recessed member 122 is connected to the other side of the second flat member 112, and the other side of the second recessed member 122 is connected to one side of a second protruded member 132.

In addition, the second recessed member 122 is formed to recess downward so as to have a predetermined curvature as illustrated in FIG. 2.

As illustrated in FIG. 2, the third recessed member 123 is connected to the third flat member 113. In addition, the third recessed member 123 is formed to recess downward so as to have a predetermined curvature as illustrated in FIG. 2.

Here, the radius R1 of the third recessed member 123 is preferably 6.6021 mm as the radius of the first recessed member 121; however, the radius is not limited thereto.

The fourth recessed member 124 is connected to the fourth flat member 114 and is coupled to the third recessed member 123. In addition, the fourth recessed member 124 is formed to recess downward so as to have a predetermined curvature as illustrated in FIG. 2.

A top surface of the 3D kerf 100 has a wave shape which bends alternately one or more times, the top surface being parallel to a surface of the tread 210.

Specifically, the first and second recessed members 121 and 122, the first and second protruded members 131 and 132, the third and fourth recessed members 123 and 124, and the third and fourth protruded members 133 and 134 described above are coupled to each other in consecutive order, and thus a wave shape is formed as a whole as illustrated in FIG. 2.

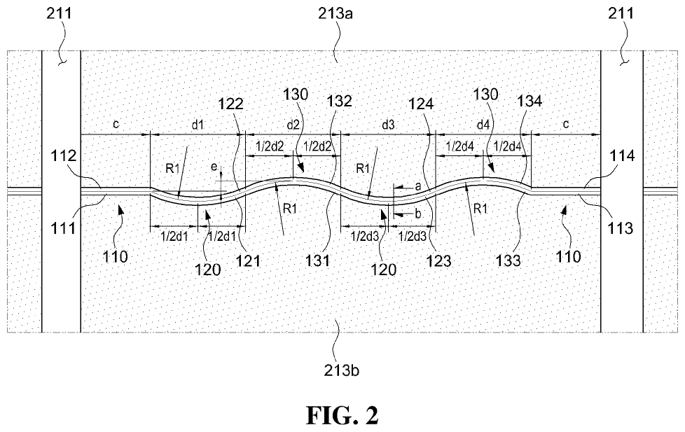

FIG. 3 is a cross-sectional view taken along line a-b in FIG. 2.

A side surface of the 3D kerf 100 has a trapezoid shape which bends alternately one or more times, the side surface being parallel to the one or more blocks 213.

Regarding a feature described above, the third and fourth recessed members 123 and 124 formed between the first and second blocks 213a and 213b are illustrated as an example in FIG. 3 and are described in detail based thereon.

A thickness f of the 3D kerf 100 is 0.2 mm to 0.4 mm and preferably 0.4 mm. In FIG. 3, the thickness is the thickness f of the third and fourth recessed members 123 and 124. Besides, the same is true of thickness f of the first and second flat members 111 and 112, the third and fourth flat members 113 and 114, the first and second recessed members 121 and 122, the first and second protruded members 131 and 132, or the third and fourth protruded members 133 and 134.

In addition, a shortest distance (j+j) from one end of a recessed part of the 3D kerf 100 to one end of a protruded part of the 3D kerf 100 is twice a shortest distance j between both ends of the third and fourth recessed members 123 and 124 illustrated in FIG. 3, and the shortest distance (j+j) is 2 mm to 3 mm and preferably 2.4 mm.

In addition, in FIG. 3, a depth g of the third and fourth members 123 and 124 is 7 mm.

Also, a radius R2 of a bent part of the fourth recessed member 124 is 0.4 mm, and an angle between a horizontal line in a right-left direction and a tangent line of the third recessed member 123 based on FIG. 3 is 30 degrees.

The protruded portion 130 has one or more protruded members 131, 132, and 133 which have a predetermined curvature and are formed to protrude in the other direction of the circumferential direction of the tire 200.

The protruded portion 130 includes the first protruded member 131, the second protruded member 132, the third protruded member 133, and the fourth protruded member 134.

The first protruded member 131 is connected to the first recessed member 121. Specifically, one side of the first protruded member 131 is connected to the other side of the first recessed member 121, and the other side of the first protruded member 131 is continuously connected to one side of the third recessed member 123.

In addition, the first protruded member 131 is formed to have a predetermined curvature.

The second protruded member 132 is connected to the second recessed member 122 and is coupled to the first protruded member 131. Specifically, one side of the second protruded member 132 is connected to the other side of the second recessed member 122, and the other side of the second protruded member 132 is continuously connected to one side of the fourth recessed member 124.

In addition, the second protruded member 132 is formed to have a predetermined curvature, and the radius R1 of the second protruded member 132 is preferably 6.6021 mm as the radius of the first recessed member 121 and the third recessed member 123; however, the radius is not limited thereto.

The third protruded member 133 is connected to the third recessed member 123. Specifically, one side of the third protruded member 133 is connected to the other side of the third recessed member 123, and the other side of the third protruded member 133 is continuously connected to one side of the third flat member 113.

In addition, the third protruded member 133 is formed to have a predetermined curvature.

The fourth protruded member 134 is connected to the fourth recessed member 124 and is coupled to the third protruded member 133. Specifically, one side of the fourth protruded member 134 is connected to the other side of the fourth recessed member 124, and the other side of the fourth protruded member 134 is continuously connected to one side of the fourth flat member 114.

The flat portion 110, the recessed portion 120, and the protruded portion 130 described above are continuously connected. Specifically, the first and second flat members 111 and 112, the first and second recessed members 121 and 122, and the first and second protruded members 131 and 132 are connected in consecutive order, and a shortest distance d1 between both ends of the first and second recessed members 121 and 122 is 5.5 mm equal to a shortest distance d2 between both ends of the first and second protruded members 131 and 132.

In addition, the third and fourth flat members 113 and 114, the third and fourth recessed members 123 and 124, and the third and fourth protruded members 133 and 134 are connected in consecutive order, and a shortest distance d3 between both ends of the third and fourth recessed members 123 and 124 is 5.5 mm equal to a shortest distance d4 between both ends of the third and fourth protruded members 133 and 134.

Also, a shortest distance (d1+d2) from one end of the first and second recessed members 121 and 122 connected to the first and second flat members 111 and 112 to the other end of the first and second protruded members 131 and 132 is 5 mm to 12 mm and preferably 11 mm.

In addition, a shortest distance (d3 +d4) from one end of the third and fourth recessed members 123 and 124 connected to the third and fourth flat members 113 and 114 to the other end of the third and fourth protruded members 133 and 134 is 5 mm to 12 mm and preferably 11 mm.

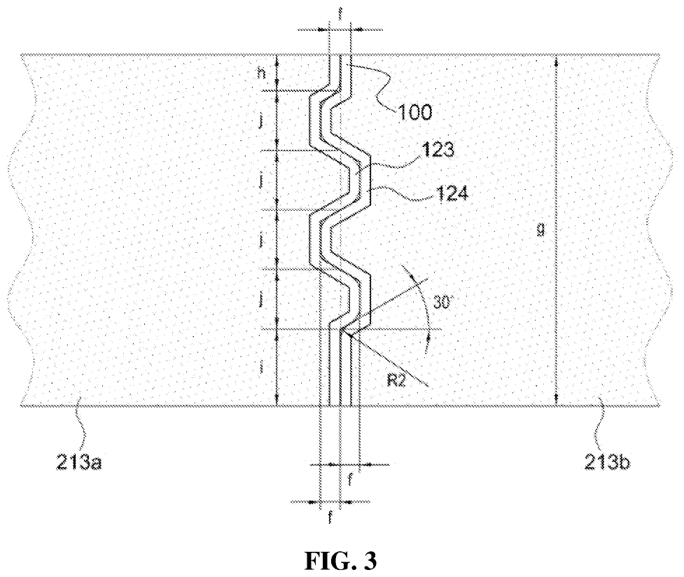

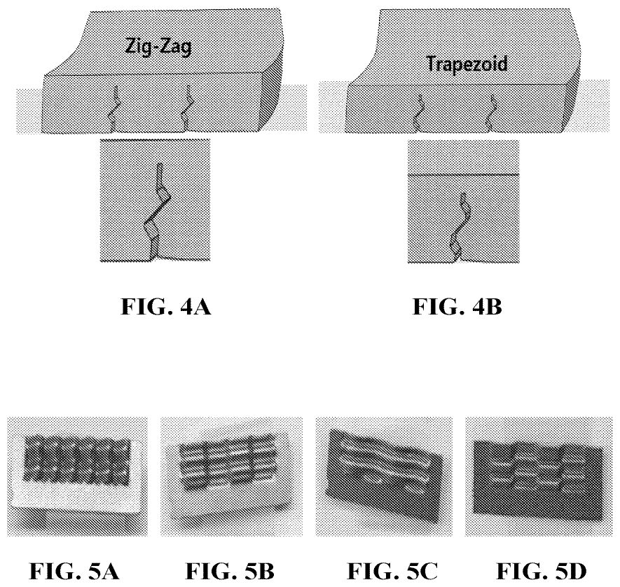

FIG. 4 is a perspective view illustrating shapes of the 3D kerf of the pneumatic tire with a 3D kerf according to the embodiment of the invention. FIG. 5 is a perspective view illustrating actual shapes of the 3D kerf of the pneumatic tire with a 3D kerf according to the embodiment of the invention.

The 3D kerf 100 of the invention is provided to cause an interlocking phenomenon to occur between the blocks 213 applied to a pattern formed at the tread 210 of the tire 200 such that a ground grip force and handling and braking performances of the tire 200 are improved, and the frictional force changes depending on the shape of the 3D kerf.

In this respect, in the invention, an experiment was carried out, in which the shape of the 3D kerf 100 was realized as a zigzag shape, a trapezoid shape, a wave shape, or the like. FIG. 4 illustrates the zigzag shape and the trapezoid shape as examples of the shape of the 3D kerf 100.

FIG. 5 illustrates 3D kerfs manufactured to have a zigzag shape, a trapezoid shape, a wave-trapezoid shape, a semi-trapezoid shape in order to evaluate the frictional force depending on the shape of the 3D kerf 100, before the 3D kerf is applied to a tire.

In FIG. 5, (A) illustrates a 3D kerf designed to have a zigzag shape at the surface of the tread 210 of the tire 200 and a zigzag shape in a depth direction from the surface of the tread 210, (B) illustrates a 3D kerf designed to have a trapezoid shape at the surface of the tread 210 of the tire 200 and a trapezoid shape in the depth direction from the surface of the tread 210, (C) illustrates a 3D kerf designed to have a wave shape at the surface of the tread 210 of the tire 200 and a trapezoid shape in the depth direction from the surface of the tread 210, and (D) illustrates a 3D kerf designed to have a trapezoid shape at the surface of the tread 210 of the tire 200 and a semi-trapezoid shape in the depth direction from the surface of the tread 210.

Experimental results thereof are shown in Table 1 and Table 2 provided below.

TABLE 1

| | | Wave- | Semi- |
|---|---|---|---|
| Zigzag | Trapezoid | Trapezoid | Trapezoid |
| 100N | 97N | 101N | 100N |
| 100N | 100N | 100N | 99N |
| 106N | 108N | 101N | 99N |

Table 1 shows results of evaluation of individual samples manufactured of SUS304 plates by performing the bending thereon, the samples having the zigzag shape in (A) of FIG. 5, the trapezoid shape in (B) of FIG. 5, the wave-trapezoid shape in (C) of FIG. 5, and the semi-trapezoid shape in (D) of FIG. 5. First, in a dry condition, the 3D kerf 100 has a difference in degree of the frictional force as Wave-Trapezoid Shape>Zigzag Shape=Semi-Trapezoid Shape>Trapezoid Shape, it was confirmed that when the 3D kerf has the wave-trapezoid shape, the maximum frictional force is generated.

Next, in a wet condition, the 3D kerf 100 has a difference in degree of the frictional force as Wave-Trapezoid Shape=Trapezoid Shape=Zigzag Shape>Semi-Trapezoid Shape, and it was confirmed that when the 3D kerf has the semi-trapezoid shape, the minimum frictional force is generated.

Lastly, in a snow condition, the 3D kerf 100 has a difference in degree of the frictional force as Trapezoid Shape>Zigzag Shape>Wave-Trapezoid Shape>Semi-Trapezoid Shape, and it was confirmed that when the 3D kerf has the trapezoid shape, the maximum frictional force is generated.

As a result of evaluation of the frictional force, the frictional force was relatively high with the zigzag shape and the trapezoid shape; however, a defect rate was high due to those complicated shapes when the sample was manufactured of the SUS304 material by performing the bending thereon.

In addition, as a result of evaluation of design strength of the manufactured wave-trapezoid shape and semi-trapezoid shape, the strength of the wave-trapezoid shape was found to be higher than the strength of the semi-trapezoid shape by about 5%, and thus the 3D kerf having the wave-trapezoid shape was determined to be applied to a mold.

TABLE 2

| | General | 3D kerf |
|---|---|---|
| | kerf | (Wave-Trapezoid) |
| Snow handling | 100 | 108 |
| Snow braking | 100 | 107.4 |
| Snow acceleration | 100 | 105.3 |

Table 2 shows evaluation of snow performance, and the tire 200 was manufactured as a 235/45R18V tire for all seasons. As a result of performance evaluation, the snow handling was more improved by 8% than a general kerf, the snow braking was more improved by 7.4% than the general kerf, and the snow acceleration was more improved by 5.3% than the general kerf.

According the above-described configuration, an effect of the invention is as follows. The snow performance can be improved by inserting a 3D kerf into a kerf groove of a tire tread, the 3D kerf including a top surface having a wave shape and a side surface having a trapezoid shape.

In addition, according the above-described configuration, another effect of the invention is as follows. Since one or more 3D kerfs come into close contact with and are fixed between one or more blocks as being inserted into one or more kerf grooves, an interlocking phenomenon between blocks can occur to improve a ground grip force and handling and braking performances of the tire.

Effects of the invention are to be construed not to be limited to the above-mentioned effects but to include any effect that can be derived from configurations of the invention described in the detailed description of the preferred embodiment and claims of the invention.

The description of the invention described above is provided as an example, and a person of ordinary skill in the art to which the invention pertains can understand that it is possible to easily modify the invention to another embodiment without changing the technical idea or essential feature of the invention. Therefore, the embodiments described above have to be understood as exemplary embodiments in every aspect and not as examples to limit the invention. For example, each configurational element described as a single unit can be realized in a distributed manner. Similarly, the configurational element described in a distributed manner can be realized in a combined manner.

The scope of the invention has to be represented by the claims to be described below, and meaning and the scope of the claims and every modification or modified example derived from an equivalent concept of the claims have to be construed to be included in the scope of the invention.

What is claimed is:

1. A pneumatic tire comprising:
a tread; and
first and second shoulders formed at first and second sides of the tread and having a circular shape,
wherein the tread includes:
first and second grooves disposed on a surface of the tread and extend in a circumferential direction of the of the circular shape; and
a plurality kerf grooves disposed on the surface of the tread to extend in an axial direction of the circular shape, the plurality of kerf grooves comprising a first set of kerf grooves provided between the first shoulder and the first groove, a second set of kerf grooves provided between the first and second grooves, and a third set of kerf grooves provided between the second groove and the second shoulder,
wherein each of the plurality kerf grooves includes:
a first straight portion extending in the axial direction;
a first concave portion extending from the first straight portion and in the axial direction and having a first radius of curvature;
a first convex portion extending from the concave portion and in the axial direction and having a second radius curvature;
a second concave portion extending from the first convex portion and in the axial direction and having a third radius of curvature;
a second convex portion extending from the second concave portion and in the axial direction and having a fourth radius of curvature; and
a second straight portion extending from the second convex portion and in the axial direction,
wherein for the second set of the kerf grooves, an end of the first straight portion opposite from the first concave portion extend to the first groove, and an end of the second straight portion opposite from the second convex portion extend to the second groove, and
wherein the plurality of kerf grooves have a trapezoid shape in a depth direction of the thread.

2. The pneumatic tire according to claim 1, wherein an overall shape of the plurality kerf grooves has a wave shape.

3. The pneumatic tire according to claim 1, wherein a length of one of the first and second concave portions in the axial direction is equal to a length of one of the first and second convex portions in the axial direction.

4. The pneumatic tire of claim 1, wherein a depth of the plurality of kerf grooves is 7 mm.

5. The pneumatic tire according to claim 1, wherein a length of the first concave portion or the second concave portion in the axial direction is 5 mm to 12 mm.

6. The pneumatic tire according to claim 1, wherein a length of the first convex portion or the second convex portion in the axial direction is 5 mm to 12 mm.

7. The pneumatic tire according to claim 1, wherein the first radius of curvature is equal to the third radius of curvature.

8. The pneumatic tire according to claim 5, wherein the second radius of curvature is equal to the fourth radius of curvature.

9. The pneumatic tire of claim 1, wherein at least one of the first, second, third or fourth radius of curvature is equal to 6.6021 mm.

10. The pneumatic tire according to claim 1, wherein a width the plurality kerf grooves in the circumferential direction is 0.2 mm to 0.4 mm.

11. The pneumatic tire according to claim 3, wherein a length of the first straight portion is equal to a length of the second straight portion.

12. A tire comprising:
first shoulder having a circular shape;
a second shoulder having the circular shape and spaced apart from the first shoulder; and
a tread provided between the first and second shoulders to form a surface around a circumference of the first and second shoulders, wherein the thread includes:
first and second grooves provided parallel to each other and extending along the surface in a circumferential direction; and
a plurality of kerf grooves provided between at least one of (a) the first and second grooves, (b) the first groove and the first shoulder, or (c) the second groove and the second shoulder, wherein each of the kerf grooves has a wave shape in an axial direction of the circular shape, and a prescribed shape in a depth direction of the kerf groove,
wherein the wave shape is provided by a first concave portion having a first radius of curvature and a first convex portion having a second radius of curvature, and
wherein the prescribed shape in the depth direction comprises a first linear section extending perpendicular from the surface, a second linear section extending in a first angle from the first linear section, a third linear section extending in a second angle from the second linear section, and a fourth linear section extending in a third angle from the third linear section, the first and third linear sections being parallel to each other and the second and fourth linear sections being non-parallel to each other.

13. The tire of claim 12, wherein the wave shape further comprises a second concave portion having a third radius of curvature, and a second convex portion having a fourth radius of curvature, the first convex portion provided between the first and second concave portions and the second concave portion being provided between the first and second convex portions.

14. The tire of claim 13, wherein the wave shape further comprises first and second linear portions, the first and second concave and convex portions being provided between the first and second linear portions, and the first and second concave, convex and linear portions having the same prescribed shape in the depth direction.

15. The tire of claim 12, wherein the prescribed shape further comprises a fifth linear section extending in a fourth angle from the fourth linear section, a sixth linear section extending in the first angle from the fifth linear section, a seventh linear section extending in the second angle from the sixth linear section, and a eighth linear section extending in the third angle from the seventh linear section, wherein the first, third and fifth linear sections are parallel to each other, the second and sixth linear sections are parallel to each other, and fourth and eighth linear sections are parallel to each other.

16. The tire of claim 15, wherein the prescribed shape further comprises a ninth linear section extending in the fourth angle from the eighth linear section, a tenth linear section extending in the first angle from ninth linear section, and an eleventh linear section extending in the second angle from the tenth linear section, the first and eleventh linear sections being parallel to each other, and the second and tenth linear sections being parallel to each other.

17. The tire of claim 16, wherein depth of the kerf groove in the depth direction is 7 mm.

18. The tire of claim of claim 14, wherein the first, second, third and fourth radius of curvature is the same.

19. The tire of claim 12, wherein the width of each kerf groove in the circumferential direction is between 0.2 mm to 0.4 mm.

20. The tire of claim of claim 18, wherein a length of the first and second concave and convex portions in an axial direction is at least 22 mm.
